(19) United States
(12) Patent Application Publication
(10) Pub. No.: US 2018/0167739 A1
(43) Pub. Date: Jun. 14, 2018

(54) SOUND PRODUCTION UNIT

(71) Applicants: Xiaojiang Gu, Shenzhen (CN); Wei Pang, Shenzhen (CN)

(72) Inventors: Xiaojiang Gu, Shenzhen (CN); Wei Pang, Shenzhen (CN)

(73) Assignee: AAC Technologies Pte. Ltd., Singapore city (SG)

(21) Appl. No.: 15/416,276

(22) Filed: Jan. 26, 2017

(30) Foreign Application Priority Data
Dec. 12, 2016 (CN) 201621359978.8

(51) Int. Cl. H04R 9/06; H04R 1/02; H04R 31/00

(52) U.S. Cl. CPC H04R 9/06; H04R 2400/11; H04R 31/006; H04R 1/023

(57) ABSTRACT

The present disclosure provides a sound production unit. The sound production unit includes a frame with a receiving space encircled by a frame side wall, a magnetic circuit system and a vibrating system received in the receiving space, and a front cover matched with the frame, wherein the vibrating system comprises a diaphragm fixedly connected to the frame, the front cover comprises a bottom surface connected with the diaphragm and a front cover outside surface bent and extended from the edge of the bottom surface, the front cover outside surface is a metal surface, and the sound production unit further comprises an insulating film stuck on the front cover outside surface.

### FIELD OF THE DISCLOSURE

The present disclosure relates to the technical field of electro-acoustic conversion and, specifically, to a sound production unit.

### BACKGROUND

With the development of the mobile Internet age, the number of smart mobile devices is growing. Among the many mobile devices, the mobile phone is undoubtedly the most common and most portable mobile terminal equipment. At present, the function of the mobile phone is extremely diverse, One of the function is high tone quality of the music function, and the sound production unit of the mobile phone is one of the essential elements to achieve this high tone quality music features.

In a relevant technology, the sound production unit generally includes a frame for receiving a magnetic circuit system and a vibration system, and a front cover matched with the frame and disposed on the frame, wherein the magnetic circuit system includes a yoke and a magnet assembled in the yoke to form a magnetic gap, and the vibration system includes a diaphragm fixedly disposed around the frame and a voice coil inserted into the magnetic gap and configured for driving the diaphragm to vibrate. When current flows into the voice coil, the voice coil in the magnetic gap moves due to the action of the magnetic field, and the movement is changed with the change of the current to drive the diaphragm to vibrate up and down, so that sound is produced.

The relevant electronic device is provided with the sound production unit and other electronic device units, the other electronic device units include an antenna, a lens, a screen and the like, the electronic device units therein may release static electricity, the front cover of the sound production unit is generally made of metal, and when the static electricity contacts the front cover, certain magnetic field is produced to interfere with the electronic device units, so that the performance of the electronic device is poor.

Therefore, it is desired to provide a sound production unit to overcome the aforesaid problems.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a three-dimensional structure of a sound production unit provided by the present disclosure;

FIG. 2 is an exploded schematic diagram of the sound production unit shown in FIG. 1; and

FIG. 3 is a partial exploded schematic diagram of another viewing angle of the sound production unit shown in FIG. 1.

### DETAILED DESCRIPTION

The present disclosure will be described in detail below with reference to the attached drawings and embodiments thereof.

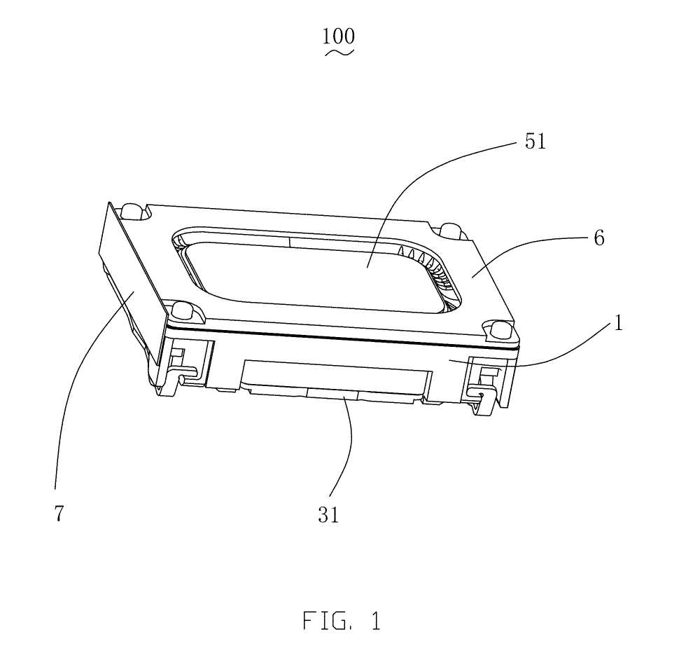

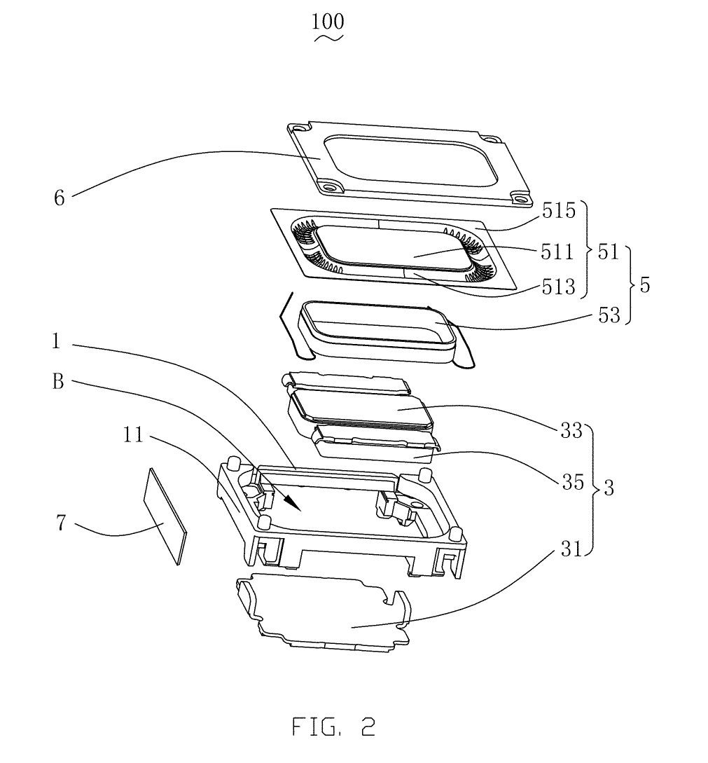

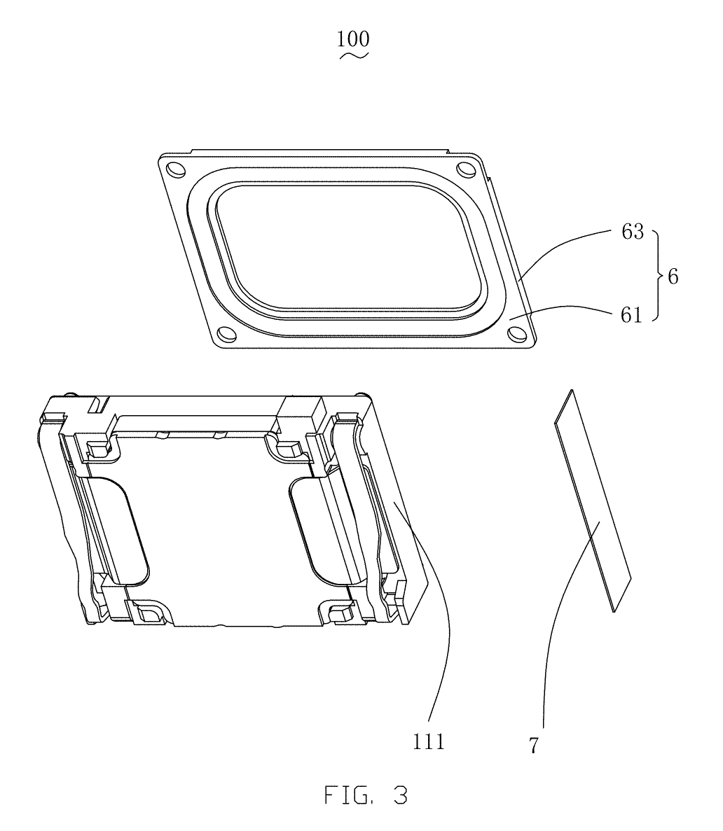

As shown in FIGS. 1-3, a sound production unit 100 includes a frame 1 with a receiving space B, a magnetic circuit system 3 and a vibration system 5 stacked in the receiving space B, a front cover 6 matched with the frame 1, and an insulating film 7 stuck on the front cover 6.

The receiving space B is encircled by a frame side wall 11, and the frame side wall 11 includes a frame outside surface 111 away from the magnetic circuit system 3.

The magnetic circuit system 3 includes a yoke 31 disposed at the bottom of the frame 1, a main magnet 33 stuck on the yoke 31, and a secondary magnet 35 stuck on the yoke 31 and encircling the main magnet 33. A magnetic gap is formed between the main magnet 33 and the secondary magnet 35.

The vibration system 5 includes a diaphragm 51 fixedly disposed at the top of the frame 1 and a voice coil 53 disposed in the magnetic gap 32 and configured for driving the diaphragm 51 to vibrate. The diaphragm 51 includes a dome portion 511, a suspension portion 513 extended outwards from the dome portion and a fixed portion 515 extended outwards from the suspension portion, wherein the fixed portion 515 is sandwiched between the front cover 6 and the frame 1, one end of the voice coil 53 is fixedly connected to one lateral surface of the diaphragm 51, and the other end of the voice coil 53 is inserted into the magnetic gap.

The front cover 6 includes a bottom surface 61 connected with the fixed portion 515 and a front cover outside surface 63 bent and extended from the edge of the bottom surface 61. The front cover outside surface 63 is a metal surface. The front cover 6 is a full-metal front cover or formed by integrated injection molding of a metal part and a plastic part, and specifically, can be made of iron, copper, aluminum or alloy or the like. When the metal part is injection-molded with the plastic part, the front cover outside surface 63 is a naked metal surface.

In this embodiment, one part of the insulating film 7 is stuck on the frame outside surface 111, while the other part is stuck on the front cover outside surface 63. In other embodiments, the insulating film 7 can be only stuck on the front cover outside surface 63. Specifically, the insulating film 7 is made of polyethylene terephthalate. When the front cover is injection-molded from the metal part and the plastic part, the front cover outside surface 63 is also a metal surface, and the insulating film 7 can be only stuck on the naked metal surface. The quantity of the insulating film 7 can be one or more, and in this embodiment the quantity is one and the insulating film 7 is in a rectangular shape.

Compared with the relevant technology, the sound production unit provided by the present disclosure has the advantages that the electronic device units in the electronic device approach the sound production unit to release static electricity, so that the front cover of the sound production unit produces a magnetic field, and the insulating film is stuck on the front cover outside surface to insulate the static electricity, therefore, the technical problem of poor performance of the electronic device due to electrostatic interference with the electronic device units is solved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A sound production unit, comprising:
a frame with a receiving space encircled by a frame side wall;
a magnetic circuit system received in the receiving space;
a vibration system received in the receiving space; and
a front cover matched with the frame;
wherein the vibration system comprises a diaphragm fixedly connected to the frame, the front cover comprises a bottom surface connected with the diaphragm and a front cover outside surface bent and extended from the edge of the bottom surface, the front cover outside surface is a metal surface, and the sound production unit further comprises an insulating film stuck on the front cover outside surface.

2. The sound production unit as described in claim 1, wherein the insulating film is made of polyethylene terephthalate.

3. The sound production unit as described in claim 1, wherein the front cover is made of metal.

4. The sound production unit as described in claim 1, wherein the front cover is formed by integrated injection molding of a metal part and a plastic part.

5. The sound production unit as described in claim 1, wherein the frame side wall comprises a frame outside surface away from the magnetic circuit system, one part of the insulating film is stuck on the frame outside surface, while the other part is stuck on the front cover outside surface.

6. The sound production unit as described in claim 2, wherein the frame side wall comprises a frame outside surface away from the magnetic circuit system, one part of the insulating film is stuck on the frame outside surface, while the other part is stuck on the front cover outside surface.

7. The sound production unit as described in claim 3, wherein the frame side wall comprises a frame outside surface away from the magnetic circuit system, one part of the insulating film is stuck on the frame outside surface, while the other part is stuck on the front cover outside surface.

8. The sound production unit as described in claim 4, wherein the frame side wall comprises a frame outside surface away from the magnetic circuit system, one part of the insulating film is stuck on the frame outside surface, while the other part is stuck on the front cover outside surface.
